(19) United States
(12) Patent Application Publication
(10) Pub. No.: US 2004/0050479 A1
(43) Pub. Date: Mar. 18, 2004

(54) Conformable sheet

(76) Inventors: Alasdair McEwen, Cumbria (GB); Jillian Johnstone, Cumbria (GB)

Correspondence Address: Wenderoth Lind & Ponack, Suite 800, 2033 K Street N W, Washington, DC, 20006, US

(21) Appl. No.: 10/343,784

(22) PCT Filed: Aug. 2, 2001
(86) PCT No.: PCT/EP01/08985

(30) Foreign Application Priority Data
Aug. 5, 2000 (GB) 0019166.8

(51) Int. Cl. B32B 1/00

(52) U.S. Cl. 156/166; 156/230; 428/292.1

(57) ABSTRACT

A substantially planar sheet having two opposable surfaces, the sheet having at least one layer formed from a first optionally polymeric material and a second optionally polymeric material, the second material having a lower elasticity modulus (1% Secant) than the first material, incorporation of the second material producing a sheet having a tensile strength and/or elasticity modulus of about 90% or less of that of a sheet without such material when measured in any direction parallel to the sheet surface. Such conformable sheets and films are particularly useful for labelling and graphic art applications.

The present invention relates to improvements in sheet-like materials, for example polymeric films.

Sheet-like materials (which include films) are often used in applications where they are applied to uneven, rough or curved surfaces, and/or to surfaces which have protrusions, for example screws or rivets. There is a desire for improved sheets which are less stiff and conform more easily to different shapes than do present sheets. There is therefore a desire to develop improved sheets which can be more readily applied to conformable and concave surfaces, for example with fewer or substantially no unsightly wrinkles or creases in the applied sheets. It is also desirable for such sheets to have a reduced tendency to tear, rip or break around surface protrusions. Such sheets would have particular utility as labels and/or in display and/or graphic art applications where often the sheets used are large (e.g. for point of sale displays, outdoor display applications, signage etc.).

The present invention provides sheets which address some or all of these problems and are particularly suited for use in the aforementioned applications.

Certain prior art polymeric films will now be described:

WO 97/20888 (Montell) describes polyolefin compositions and blown films obtained therefrom, the compositions being obtained by mixing: (A) a heterogeneous polyolefin composition itself comprising a fraction (A1) which is insoluble in xylene and a fraction (A2) which is soluble in xylene; (B) a polyolefin composition comprising a low density ethylene copolymer (B1) and a propylene copolymer (B2) of relatively high insolubility in xylene; and, optionally, (C) a branched propylene polymer.

WO 97/20889 (Montell) describes polyolefin compositions and blown films obtained therefrom, the compositions comprising: A) a heterogeneous polyolefin composition itself comprising a fraction (A1) which is insoluble in xylene at room temperature and a fraction (A2) which is soluble in xylene at room temperature; and B) a branched propylene polymer. The said compositions are particularly processable when used in the process for the preparation of blown films.

WO 97/49744 (Montell) describes elastomeric compositions with high flexibility and transparency which consist of (a) 10% to 20% of a propylene homopolymer or copolymer of 95% propylene with ethylene and/or CH₂═CHR olefin, (b) 5% to 20% of a copolymer insoluble in xylene at room temperature comprising propylene and ethylene, and (c) 60% to 80% of a copolymer soluble in xylene at room temperature which consists of propylene and 15 to 25% w/w ethylene and/or ethylene/CH₂═CHR mix.

WO 98/37144 (Montell) describes soft elastomeric thermoplastic polyolefin compositions consisting of (I) an heterophasic olefin polymer composition consisting of a crystalline propylene homopolymer or copolymer fraction and an elastomeric ethylene copolymer fraction and (II) an elastomeric polymer having a hardness equal to or less than 90 points and selected from the group consisting of copolymers of ethylene, ethylene/methyl acrylate copolymers, saturated or unsaturated styrene block copolymers and unsaturated norbornene polymers.

EP 0444671-A (Himont Inc.) describes films and laminates which are prepared by known filming or calendering processes using heterophasic propylene polymer compositions comprising: A) 10-60 parts by weight of homopolymer polypropylene having an isotactic index greater than 90, or crystalline copolymer of propylene with ethylene and/or other alpha-olefins containing more than 85% by weight of propylene and having an isotactic index greater than 85; B) 1040 parts by weight of a copolymer containing prevailingly ethylene, which is insoluble in xylene at room temperature; C) 30-60 parts by weight of an amorphous ethylene-propylene copolymer, soluble in xylene at room temperature and containing 40-70% by weight of ethylene; said propylene polymer compositions having a ratio between the intrinsic viscosities, in tetrahydronaphthalene at 135° C., of the portion soluble in xylene and of the portion insoluble in xylene at room temperature of from 0.8 to 1.2.

EP 0477662-A (Himont Inc.) describes films or sheets comprising an olefin polymer composition which comprises (a) from about 10 to 50 parts of a propylene homopolymer having an isotactic index greater than 80, or a copolymer of propylene with ethylene and/or an another alpha-olefin, containing over 80% propylene and having an isotactic index greater than 80; (b) from about 5 to 20 parts of a semi-crystalline copolymer fraction, which copolymer is insoluble in xylene at room or ambient temperature; and c) from about 40 to 80 parts of a copolymer fraction of ethylene with propylene and/or another alpha-olefin, and optionally with minor amounts of a diene, said copolymer fraction containing less than 40% ethylene and/or other alpha-olefin, being soluble in xylene at room temperature, and having an intrinsic viscosity from 1.5 to 4 d/g. Coextruded films or sheets and laminates wherein at least one layer is a film or sheet as described above, and films or sheets of blends of the olefin polymer composition and another olefin polymer are also disclosed.

EP 0659551-A (Himont Inc.) describes composite polyolefin films suitable for packaging comprising: A) a single or multilayer bioriented film, wherein the single layer or at least one layer of said bioriented film is propylene crystalline homopolymer; and B) a single- or multilayer cast film, wherein the single layer or at least one layer of said cast film is a layer of a composition comprising: I) propylene crystalline homopolymer, or a crystalline copolymer of propylene with ethylene and/or a C₄₋₈alpha-olefin; II) a copolymer fraction containing propylene and ethylene, insoluble in xylene at ambient temperature; III) a copolymer of ethylene with propylene and/or a C₄₋₈alpha-olefin and soluble in xylene at ambient temperature.

EP 0814127-A (Montell) describes an embrittlement resistant polymer composition having a heat distortion temperature >=60° C. consisting of (a) 80% w/w of a propylene homopolymer of isotacticity >90% or a random copolymer of propylene and either ethylene or C₄₋₁₀alpha-olefins, and (b) a flexibility enhancing amount (but non clarity adversely effecting amount) of an elastomeric copolymer of ethylene and either propylene or butene-1. Optional ingredients include at least one hindered amine stabiliser, acid neutraliser, sorbitol based clarifier compound and/or any suitable mixtures thereof.

EP 0814128-A (Montell) describes an embrittlement resistant polymer composition including ingredients to improve radiation resistance which consist of (a) a visbroken polymer composition consisting of a crystalline random copolymer of propylene and either ethylene or C₄₋₁₀alpha-olefins, and (b) polymethyl propyl 3-oxy-4-(2,2,6,6-tetramethyl)piperidinyl siloxane. Optional ingredients include acid neutralisers, sorbitol-based clarifier compounds, and/or any suitable mixtures thereof.

U.S. Pat. No. 5,677,044 (Montell) describes multilayer heat-shrinkable films in which at least one layer (A) is based on a polyolefin composition comprising a propylene copolymer and having particular crystallinity characteristics, and at least one layer (B) comprises a linear copolymer of ethylene with one or more alpha-olefins (LLDPE).

U.S. Pat. No. 6,010,772 (Montell) describes stretchable multilayer films in which at least one layer (A) thereof comprises a copolymer (I) of ethylene with one or more alpha-olefins CH₂═CHR, having a density of between 0.88 and 0.945 g/cm³, a melt index of from 0.1 to 10 g/10′ and containing up to 20 mol % of alpha-olefin CH₂═CHR (LLDPE), and at least one layer (B) comprises a heterophasic polyolefin composition having: (a) 20-100 parts by weight of a fraction which is insoluble in xylene at room temperature, comprising a propylene homopolymer or a copolymer of propylene with ethylene and/or another alpha-olefin CH₂═CHR¹, this fraction containing more than 85% by weight of units derived from propylene; and (b) 30-80 parts by weight of a fraction which is soluble in xylene at room temperature, comprising an amorphous copolymer of ethylene with propylene and/or another alpha-olefin CH₂═CHR¹, this fraction optionally containing smaller proportions of a diene and containing more than 15% by weight of units derived from ethylene.

These prior art documents do not describe or appreciate the particular problems with prior art films as those described herein. It is an object of the invention to provide films with improved properties and preferably particularly suitable for the uses described herein.

Therefore broadly in accordance with the present invention there is provided a substantially planar sheet having two opposable surfaces, the sheet comprising at least one layer comprising a first material and a second material characterised in that the second material has a lower elasticity modulus than that of the first material, incorporation of the second material producing a sheet exhibiting a tensile strength and/or elasticity modulus (preferably elasticity modulus) of about 90% or less of that of the sheet without such material measured in any direction parallel to the sheet surface

Preferably sheets of the present invention have a thickness of 50 μm or more.

In another aspect of the present invention there is provided a label of optionally improved conformability, the label comprising a first backing sheet coated with a release layer on top of which is attached a second sheet of the present invention as described herein, the second sheet optionally being provided with a printable coating on the side opposed to the first (backing) sheet.

The backing sheet may be formed from any suitable material well known in the art.

The elasticity modulus as described herein denotes the 1% Secant modulus measured by any well known standard method such as any of those described in BS 2782, ASTM D882 and/or DIN 53455.

As used herein “tensile strength” is measured by any well known standard method such as any of those described in BS 2782, ASTM D882 and/or DIN 53455.

Preferably the sheet has a tensile strength of about 88% or less, more preferably about 85% or less, for example from 86% to 88% compared to a control sheet without the second material in the layer.

Preferably the sheet has a proportionate reduction in percentage elongation of 85% or less, more preferably from about 75% to about 85%, for example from 78% to 84%, of the percentage value compared to a control sheet without the second material in the layer.

Preferably the sheet has an elasticity modulus of about 88% or less, more preferably from about 71% to about 78% (MD) and/or from about 65% to about 71% (TD) compared to a control sheet without the second material in the layer.

Preferably the sheet has an flexural stiffness of about 96% or less, more preferably from about 73% to about 84% (MD) and/or from about 86% to about 96% (TD) compared to a control sheet without the second material in the layer.

Preferably the sheet is substantially self supporting, i.e. does not need to be applied to a substrate for mechanical support although it is capable of being so applied.

Preferably the two-component layer described above as a feature of the present invention will impart and/or enhance conformability of the sheet compared with a similar sheet with only the first polymeric material. For convenience this two-component layer may be also referred to herein as a “conformability layer”.

Preferably the sheet is obtainable by a process in which the sheet is stretched from an initial size to a final size in at least one direction parallel to its surface. More preferably the sheet is bi-axially oriented, most preferably in two substantially orthogonal directions for example by stretching.

Conventionally the longitudinal direction (LD), parallel to the longest axis of a sheet, is the direction in which a sheet web passes through a production machine, and thus is also known as the machine direction (MD). For example, a sheet web may be stretched in the forward web direction (i.e. MD). Conventionally the transverse direction (TD) is normal to the LD and parallel to the sheet surface. The sheet web may also be stretched sideways (i.e. “TD”) by a suitable process such as the well known bubble and/or stenter processes Preferred sheets are those oriented in both MD and TD and such orientation may be simultaneous and/or sequential. The terms MD and TD may also denote the direction on the sheet in which (optionally anisotropic) properties are measured to give values as specified herein.

Preferably the sheet exhibits at least one (optionally all) of the following properties measured in any direction parallel to the sheet surface (optionally MD and/or TD):

(a) a tensile strength from about 100 to about 250 Nm⁻²;

(b) an elasticity modulus from about 2100 to about 3100 MPa;

(c) a percentage elongation below about 150%; and

(d) a percentage shrinkage below about 7%.

In yet another aspect of the present invention there is provided use of a composition comprising a first material and a second material characterised in that the second material exhibits a lower elasticity modulus than the first material (optionally the first and second materials are selected from those described herein) to prepare a sheet having the properties described herein and/or a conformable label as described herein.

As used herein “percentage elongation” is the increase in a linear dimension of the sheet measured after manufacture and resulting from the manufacturing and orientation process.

As used herein “percentage shrinkage” is defined as the percentage decrease in a linear dimension of a sheet after manufacture which results from its being heated to 130° C. for one minute.

More preferably sheets of the invention exhibit one or more of the following properties measured in the machine direction (MD):

(a1) a tensile strength of from about 130 to about 250 Nm⁻²;

(b1) an elasticity modulus<about 3000 MPa;

(c1) a percentage elongation<about 90%;

(d1) a percentage shrinkage<about 7% measured in the transverse direction (TD);

(a2) a tensile strength of from about 110 to about 200 Nm⁻²;

(b2) an elasticity modulus from about 2600 to about 2800 MPa;

(c2) a percentage elongation<about 120%; and/or

(d2) a percentage shrinkage<about 3.0%.

More conveniently sheets of the invention exhibit one or more (optionally all) of the following properties:

(a1) a MD tensile strength of from about 110 to about 250 Nm⁻²;

(b1) an MD elasticity modulus=<about 3000 MPa;

(c1) a MD percentage elongation=<about 120%;

(d1) a TD percentage shrinkage=<about 7%.

Most conveniently sheets of the invention exhibit one or more (optionally all) of the following properties:

(a2) a MD tensile strength of from about 130 to about 200 Nm⁻²;

(b2) an MD elasticity modulus from about 2600 to about 2800 MPa;

(c2) a MD percentage elongation=<about 90%; and/or

(d2) a TD percentage shrinkage=<about 3.0%.

Advantageously sheets of the present invention have at least one, more advantageously at least two, most advantageously at least four (for example all) of the following properties:

a MD tensile strength of from 140 to 218 Nm⁻², for example from 144 to 170 Nm⁻²;

a TD tensile strength of from 110 to 171 Nm⁻², for example from 111 to 148 Nm⁻²;

an MD elasticity modulus of from 1620 to 2000 Nm⁻², for example from 1694 to 1964 Nm⁻²;

an TD elasticity modulus of from 1050 to 1890 Nm⁻², for example from 1230 to 1882 Nm⁻²;

an MD elongation at break of from 55 to 80 Nm⁻², for example from 65 to 78 Nm⁻²;

an TD elongation at break of from 100 to 120 Nm⁻², for example from 107 to 119 Nm⁻²;

an MD percentage shrinkage of from 5.0 to 12.0%, for example from 5.1 to 7.2%; and/or

an TD percentage shrinkage of at least 1.7, for example from 1.7 to 3.2%.

Preferably the first material forms the bulk and/or the continuous phase of the sheet, and more preferably the first material comprises a polymer.

Preferably the second material is homogeneously located with the first material, and more preferably is dispersed (such as in an emulsion) and/or dissolved (such as in a solid solution) therein. Most preferably the second material comprises a polymer.

Preferably the second material is present in the or each conformability layers in an amount from about 5% to about 30%, and more preferably from about 10% to about 20%, by weight of the first material in said layer.

Preferably the elasticity modulus of the first material is from about 2000 to about 3000 MPa (TD or MD, preferably MD).

Preferably the elasticity modulus of the second material is from about 1000 to about 2500 MPa (TD or MD, preferably MD).

Sheets of the present invention may be formed from any suitable, well known sheeting materials (optionally as the first material) and/or may use such sheeting materials as supporting substrates (for example if a sheet of the present invention is not self supporting). Suitable sheeting materials include any of the following: polymer films (especially polyolefinic films), paper, synthetic paper, woven fabrics, non-woven fabrics, ceramic sheets metallic fiber sheets, metallized sheets or films, metallic foils, metallic plates and/or multilayer composite sheets formed by any suitable combinations and/or mixtures of said materials. For sheets intended for use as labels, polyolefin films are preferred, especially the oriented polypropylene films described in EP0202812-A the contents of which are hereby incorporated by reference.

Preferably the first material is a polymeric material and more preferably a thermoplastic polymer. More preferably the first material is a homopolymer and/or a polymer of randomly oriented amorphous non-crystalline polymer chains. Most preferably the first material is selected from polyolefins (e.g. polypropylene and/or polyethylene), polyurethanes, polyvinylhalides (e.g. PVC), polyesters (e.g. polyethylene terephthalate—PET), polyamides (e.g. nylons), and/or other non-hydrocarbon polymers. In particular the first material can be a polyolefin, for example polypropylene.

After extrusion of a polypropylene film by conventional extrusion techniques, the film may be heated and molecularly oriented by stretching in for example the MD and/or TD. Orientation of the film may be achieved by any suitable technique, for example by the well known bubble and/or stenter processes. The film thus formed comprises biaxially oriented polypropylene (also known herein as BOPP). Therefore a particularly preferred type of first polymeric material is a molecularly oriented, isotactic polypropylene homopolymer, especially BOPP.

Preferably the second polymeric material is one or more elastomers, polyolefins and/or mixtures thereof; more preferably a thermoplastic polyolefin optionally with a hardness value above about 90 points, conveniently in an amount of from about 5% to about 25% w/w of the total polymer composition.

Preferably the second polymer is selected from at least one of the group consisting of: homopolymers and copolymers containing one or more repeat units derived from any ethylenic polymer precursors; copolymers containing one or more repeat units derived from any propylenic polymer precursors, copolymers containing one or more repeat units derived from any styrenic polymer precursors (more preferably selected from: styrene butadiene copolymers (SBS); styrene-isoprene-styrene block copolymers (SIS), styrene-ethylene-butylene-styrene block copolymers (SEBS) and/or saturated styrenic block copolymers); copolymers containing one or more repeat units derived from any CH₂═CHR (R denotes any saturated C₁₋₂₀ hydrocarbon group, preferably C₁₋₁₀ alkyl) olefinic polymer precursors, and/or copolymers containing one or more repeat units derived from any norbornenic polymer precursors.

Conveniently the second polymeric material comprises a thermoplastic polyolefin polymer (such as that available from Montell under the designation Adflex X500F) and/or a SEBS, SBS and/or saturated styrenic block copolymer (such as those available commercially from Asahi Chemicals under the trademark Tuftec®, e.g. Tuftec® L515).

The film can be a single layer containing a major proportion of polypropylene, for example an isotactic propylene homopolymer, but it can also be a coextruded multilayer film where the polymer of at least one layer is an isotactic propylene homopolymer, the polymer of one or both outer layers being a polymer having better conformability than the isotactic propylene homopolymer. Such surface layer polymers may be, for example, a copolymer of propylene with a minor amount of one or more other α-olefins, such as ethylene and/or butylene-1.

The sheets of the present invention can consist of only one layer, i.e. the conformability layer described herein. However, it is preferred that the sheets are multilayered, i.e. consist of a plurality of layers. The layers can be combined by lamination or co-extrusion. More preferably the sheets consist of at least three layers where the or each conformability layer is sandwiched between other layers such that none of the conformability layers forms either outer surface of the sheets.

Thus, for example, a film of the invention can have three layers with the polymer of a central or core layer being formed from the second polymeric material. The core layer may have a thickness of about 90 to about 98% of the total thickness of the film. The remainder of such three layer films can then have two outer layers of the first polymeric material, with each outer layer having substantially identical thicknesses.

Other films of the present invention consist of five coextruded layers with a central core layer, two layers contiguous to the central core layer and two outermost layers, where the central core layer and such contiguous layers include the second polymeric material and the two outer layers are formed from the first polymeric material. Preferably the central core layer has a thickness from about 70% to about 96%, more preferably from about 76% to about 90%, of the total thickness of the film. Preferably each of such contiguous layers has substantially the same thickness, which is more preferably from about 1% to about 6%, and most preferably from about 1% to about 2%, of the total thickness of the film. Preferably each outer layer has substantially the same thickness, which is more preferably from about 1% to about 6%, and most preferably from about 1% to about 2%, of the total thickness of the film.

Films of the invention can also be made by the laminating of two coextruded films.

One or more layers of films of the present invention can be opaque or transparent, depending on the end use of the film. Such layers can also include voids introduced by stretch orienting a layer containing particles (preferably substantially spherical particles) of a material which is higher melting than and immiscible with the layer material (e.g. if the layer is formed from isotactic polypropylene homopolymer, such particles can be of polybutylene terephthalate, as described, for example, in U.S. Pat. No. 4,632,869 and U.S. Pat. No. 4,720,716).

Sheets of the present invention usually have one or more of the following preferred properties: an MD elasticity modulus of from about 1600 to about 2600 MPa; a TD elasticity modulus of from about 1200 to about 2200 MPa; a % elongation after manufacture of from about 60% to about 85% (MD) and/or of from about 110% to about 115% (TD); a % shrinkage after manufacture of from about 5% to about 7% (MD) and/or of from about-1 to about 2.5% (TD) after the sheet has been heated to 130° C. for one minute.

In an optional embodiment of the present invention the sheet has a mean thickness above about 75 μm, more preferably from about 50 μm to about 150 μm.

Preferred sheets of the present invention include one or more free radical scavengers and/or UV attenuating materials optionally located in the conformability layer. More preferred sheets include UV attenuating materials in an amount such that the sheets retain at least 50% of their mechanical properties after exposure to artificial weathering (Dry Cycle 0.35W/Nm² C340 nm BST 63°) for at least about 1500 hours, preferably at least about 2000 hours, more preferably at least about 2500 hours (which equates to an outdoor lifetime of approximately 2 years). Most preferably the sheet include UV attenuating materials in an amount from about 0.1% to about 0.5% by weight of the first material.

UV attenuating materials will be understood to be any materials which acts to reduce and/or block the effect of incident UV radiation on the film by any suitable chemical and/or physical effects, such as by reflection, absorption, refraction, scattering and/or otherwise. Examples of suitable UV attenuating materials include any of the following and mixtures thereof: benzophenones; bentriazoles; and hindered amine stabilisers, for example that available from Ciba under the trade name Tinuvin 783. The UV attenuating material can also be added to the film as a coating in which case it is preferably present in an amount in the coating composition of from about 0.1% to 20%, more preferably 1% to about 10% w/w.

Solar radiation includes UV radiation with wavelengths up to about 400 nm; UV-A has a wavelength from about 315 nm to about 400 nm; UV-B has a wavelength from about 290 nm to about 315 nm; and UV-C has a wavelength of up about 290 nm. Preferred UV attenuating materials are those particularly effective against UV-B as this usually causes the most damage to polymeric materials such as films of the present invention.

It will be understood by those skilled in the art that conformable sheets of the present invention can include further additives and/or may be coated by any suitable means to provide additional desired end properties to the sheet.

Before coating a sheet of the present invention it may, if desired, be subjected to a chemical or physical surface-modifying treatment to improve adhesion of the coating to the sheet, thereby reducing the possibility of the coating peeling or being stripped from the sheet. Known prior art techniques for surface pre-treatment prior to coating include, for example, film chlorination, i.e. exposure of the film to gaseous chlorine; treatment with oxidising agents, for example chromic acid, hot air or steam treatment; flame treatment and the like. A preferred treatment, because of its simplicity and effectiveness, is the so-called electronic treatment in which the sheet is passed between a pair of spaced electrodes to expose a surface of the sheet to a high voltage electrical stress accompanied by corona discharge.

If even adhesion of the coating is desired, it is preferred to apply an intermediate continuous coating of primer material to a surface of the sheet which has first been treated by any of the above methods. Primer materials which can be used include titanates and poly-(ethylene imine), and they can be applied as conventional solution coatings, for example poly-(ethylene imine) can be applied as either an aqueous or organic solvent solution, e.g. in ethanol comprising about 0.5 wt. % of the imine.

One or more of the layers of sheets of the invention (such as films) can contain additives and/or coatings conventionally employed in the manufacture of sheets, and such additives and/or coatings can be added for more than one effect. Such additives and/or coatings can be selected from one or more of the following, mixtures thereof and/or combinations thereof: dyes; pigments, colorants; metallised and/or pseudo-metallised coatings; lubricants, anti-static agents (cationic, anionic and/or non-ionic, e.g. poly-(oxyethylene) sorbitan monooleate), anti-oxidants, surface-active agents, stiffening aids, slip aids (for example hot slips aids or cold slip aids which improve the ability of a film to slide satisfactorily across surfaces at about room temperature, e.g. micro-crystalline wax; gloss improvers, prodegradants, barrier coatings to alter the gas and/or moisture permeability properties of the film (such as polyvinylidene halides, e.g. PVdC); anti-blocking aids (for example microcrystalline wax, e.g. with an average particle size from about 0.1 to about 0.6 μm); tack reducing additives (e.g. fumed silica); particulate materials (e.g. talc); additives to reduce coefficient of friction (COF) (e.g. terpolymers of about 2 to 15 wt. % of acrylic or methacrylic acid, 10 to 80 wt. % of methyl or ethyl acrylate, and 10 to 80 wt. % of methyl methyacrylate, together with colloidal silica and carnauba wax, as described in U.S. Pat. No. 3,753,769); sealability additives; additives to improve ink adhesion and/or printability, cross-linking agents (e.g. melamine formaldehyde resin); adhesive layers (e.g. a pressure sensitive adhesive); and/or an adhesive release layers (e.g. for use as a liner in peel plate label applications).

Some or all of the additives listed above may be added together as a composition to coat the sheet of the present invention and/or form a new layer which may itself be coated (i.e. form the central core layer of a final sheet) and/or may form the outer or surface layer of the sheet. Alternatively some or all of the preceding additives may be added separately and/or incorporated directly into the bulk of the sheet, optionally during and/or prior to sheet formation (e.g. as part of the original polymer composition), and thus they may or may not form layers or coatings as such.

A coating composition may be applied to a treated surface of a sheet (e.g. a polymer film) in any suitable manner, for example by gravure coating, roll coating, dipping, spraying, etc. Excess liquid (e.g. aqueous solution) can be removed by squeeze rolls, doctor knives, etc. The coating composition will ordinarily be applied in such an amount that following drying there will have been deposited, a smooth, evenly distributed layer of from about 0.02 to about 0.10 micron thickness. In general, the thickness of the applied coating should be sufficient to impart the desired characteristics to the substrate sheet. Once applied to the sheet, a coating may be subsequently dried by hot air, radiant heat or by any other suitable means to provide a conformable sheet of the present invention having other desired properties (e.g. a non-water soluble, optionally clear, adherent, glossy coated film useful, for example, in labelling and/or graphic arts applications).

The sheets may be made by any suitable process known to those skilled in the art, for example by extrusion, lamination and/or co-extrusion processes and if desired they may be oriented, e.g. by bubble and/or stenter process(es).

In a further aspect of the present invention there is provided a label, security marking and/or display device formed from a sheet of the present invention.

Another aspect of the present invention provides for use of a sheet of the present invention in a method of manufacture of a label, tag or other display device, preferably suitable for use in the fields of labelling, graphic arts, security and/or displays.

A still further aspect of the present invention provides for the use of sheets of the present invention in methods of labelling, graphic arts, security and/or displays.

A yet still further aspect of the present invention provides for use of a first and/or second polymeric material as defined herein for the purpose of enhancing in a sheet as defined herein (the sheet optionally exhibiting improved conformability) one or more of properties as defined herein. Preferably those properties measured in any direction parallel to the sheet surface (optionally MD and/or TD) are selected from one or more (optionally all) of.

(a) tensile strength preferably from about 100 to about 250 Nm⁻²;

(b) elasticity modulus preferably from about 2100 to about 3100 MPa;

(c) percentage elongation preferably below about 150%; and/or

(d) percentage shrinkage preferably below about 7%.

Optionally the properties may be further selected to have one or more of those values given herein.

Further aspects and/or features of the present invention are given in the claims.

The invention is further illustrated by reference to the following Examples, which are by way of illustration only and are not limiting to the scope of the invention described herein. In the Examples, a five layered laminated BOPP film is prepared by a bubble process as follows.

Bubble Process

A film is formed by the coextrusion of three compositions through a triple channel annular die. A polypropylene composition (denoted as Composition A) from the middle channel of the die forms the core layer of the bubble, the composition in the outermost channel of the die forms the exterior surface of the bubble (denoted as composition B), and the composition from the inner channel forms the interior surface of the bubble (denoted as composition C).

As the three compositions are coextruded, air is blown through the die to form a tubular bubble which is cooled by passage over a mandrel within the tube, and it is externally quenched by passage through a water bath surrounding the mandrel. The tube is then heated to stretching temperature, expanded by internal gas pressure to form the bubble, and withdrawn from an expansion zone at a rate greater than that at which it is fed thereto, so that the bubble is stretched to seven times its original dimensions in both the direction of extrusion (MD) and in a direction transverse thereto (TD). The stretched tubular film is then collapsed whilst being heated, thereby forming a flat laminated film which is subsequently heat-set at a temperature of 120° C. on a matt-surfaced roller heat-setter (e.g. of the kind described in GB1124886-A).

The resultant five layered film consists of two three layered films laminated together by layers of Composition C on the interior of the bubble to form a core layer surrounded by two identical layers of Composition A and two identical outer layers of composition B which form the two outer surfaces of the film. Thus the films formed by this method have a B/A/C/A/B layered structure, the film strictly speaking being a six layer film since the inner core layer formed from Composition C is formed by laminating two such layers together.

In the following examples, the outer layer of Composition B which forms the outer surface of the film has a mean thickness of from about 0.3 to about 0.6 μm; and the central laminating core layer of composition C has a mean thickness of about 1 μm.

### COMPARATIVE EXAMPLE

### Comp I

A comparative BOPP film was prepared by the bubble process as described above, where Composition A was a stabilised propylene homopolymer suitable for film production with a melt flow index (MFI) measured at 230° C. and 2.16 kg of about 6.5 to about 9.0; Composition B was a propylene (95% w/w)/ethylene (5% w/w) copolymer; and Composition C was a propylene (82% w/w)/ethylene (1% w/w)/butylene-1 (17% w/w) terpolymer of low crystallinity.

It will be appreciated that other Examples (not necessarily tested herein) could be carried out by replacing any of Compositions A to C by other suitable compositions. For example Composition A could be replaced by a polymer of polypropylene containing a small concentration (from about 0.5% to about 1.0% w/w) of polyethylene, and/or Composition B could be replaced by a propylene (92% w/w)/ethylene (4% w/w)/butylene-1 (4% w/w) terpolymer.

### Examples 1 to 5

Films of the invention were prepared as described in Comparative Example I, except that amounts (% by weight of the polypropylene) of the thermoplastic polyolefin (available commercially from Montell under the trade name Adflex X500F) shown in Table 1 were added to the propylene homopolymer forming composition A. Stable BOPP bubbles were achieved with Adflex X500F concentrations from 5 to 25% w/w. At each stage the bubble was allowed to settle and samples were taken.

The films were tested, and the results obtained are given in the following Tables 1 and 2, as follows:

TABLE 1

| | Amount | Tensile | | Elasticity | | Elongation/ | | Shrinkage/ | |
|---|---|---|---|---|---|---|---|---|---|
| | Adflex | strength/Nm⁻² | | Modulus/MPa | | % | | % | |
| Example | X500F/wt % | MD | TD | MD | TD | MD | TD | MD | TD |
| Comp I | — | 228.4 | 187.4 | 2695 | 2397 | 86.40 | 122.6 | 7.6 | 1.5 |
| 1 | 5 | 168.9 | 147.4 | 2032 | 1882 | 78.16 | 107.4 | 5.1 | 1.7 |
| 2 | 10 | 163.4 | 141.9 | 1964 | 1486 | 75.51 | 108.7 | 6.6 | 2.1 |
| 3 | 15 | 168.0 | 136.1 | 1854 | 1670 | 70.84 | 108.9 | 5.9 | 2.3 |
| 4 | 20 | 146.9 | 115.4 | 1694 | 1391 | 70.11 | 109.4 | 6.9 | 2.5 |
| 5 | 25 | 144.8 | 111.8 | 1627 | 1230 | 65.07 | 119.0 | 7.2 | 3.2 |

TABLE 2

| | Gloss/ | Haze/ | Clarity/ | Yield/ | Av. thickness/ |
|---|---|---|---|---|---|
| Example | % | % | % | kgm⁻² | μm |
| Comp I | 94.7 | 98.2 | 2.94 | 18.90 | 56.2 |
| 1 | 94.3 | 97.5 | 2.29 | 19.06 | 57.6 |
| 2 | 94.1 | 97.4 | 2.45 | 18.75 | 56.7 |
| 3 | 92.9 | 97.2 | 2.85 | 18.59 | 57.8 |
| 4 | 86.1 | 96.6 | 3.86 | 17.63 | 61.8 |
| 5 | 74.6 | 97.5 | 5.24 | 17.86 | 60.6 |

The test method used for gloss was ASTM D2457-70 and for haze and clarity were ASTM D1003 and D1044.

The addition of Adflex X500F to a conventional film (Comp I) was successfully at 5%, 10%, 15%, 20% and 25% w/w, and no delamination was observed for any of these films.

The optical properties of the modified films were within acceptable limits, although there was a slight reduction in clarity and gloss at Adflex levels from 15% to 25%. At concentrations of Adflex of from 20% to 25% there was a slight reduction in thermal stability and an increase in TD shrinkage was observed. Increasing levels of Adflex reduced the elasticity modulus (MD), elongation (MD) and tensile strength (MD and TD) leading to a more conformable film.

### Examples 6 to 9

Films of the invention were prepared as described above except that the Adflex X500F was replaced as the modifying resin by various amounts of another resin, such as the saturated styrenic block copolymer (that available commercially from Asahi Chemicals under the trademark Tuftec® L515) as shown in Table 3.

TABLE 3

| Example | Amount of Tuftec L515/wt % |
|---|---|
| 6 | 2 |
| 7 | 8 |
| 8 | 10 |
| 9 | 20 |
| 10 | 10 (another resin)¹ |

¹The modifying resin used was EMAC 2260 not Tuftec L515.

The modifying resin used was EMAC 2260 not Tuftec L515.

A comparative prior art OPP film Comp II (UCB code ref. C50) was prepared analogous to Comp I herein and also without any modifying resin. Some of these films were tested as described above and the results are given in Tables 4 &5 below.

TABLE 4

| | Flexural | | Tensile | | Elasticity | | Elongation | | | |
|---|---|---|---|---|---|---|---|---|---|---|
| | stiffness: | | strength: | | Modulus: | | at | | Shrinkage: | |
| | Mn/m² | | Nm⁻² | | Mn/m² | | break | | % | |
| Example | MD | TD | MD | TD | MD | TD | MD | TD | MD | TD |
| Comp II | 2.147 | 1.956 | 219.9 | 193.3 | 2504 | 2348 | 85.34. | 107.6 | 4.84 | −0.26 |
| 8 | 1.549 | 1.88 | 214.2 | 170.2 | 1936 | 1539 | 66.52 | 114.9 | 11.18 | 2.81 |
| 9 | 0.9283 | 1.315 | 218.1 | 129.5 | 1644 | 1054 | 58.12 | 109 | 8.7 | −1.8 |
| 10 | 1.802 | 1.683 | 221.2 | 167.6 | 1789 | 1656 | 71.5 | 104.1 | 10.65 | 2.28 |

TABLE 5
(optical properties of film measured on a surface treated
with a corona discharge)

| Example | Gloss/% | WAH/% | NAH/% |
|---|---|---|---|
| Comp II | 92.7 | 1.6 | 5 to 10 |
| 8 | 87.4 | 1.8 | 2 to 3 |
| 9 | 86.9 | 2.6 | 2 |
| 10 | 85.0 | 2.7 | 13 to 14 |

1 A substantially planar sheet having two opposable surfaces, the sheet comprising at least one layer comprising a first material and a second material characterised in that the second material has a lower elasticity modulus than that of the first material, incorporation of the second material producing a sheet having a tensile strength and/or elasticity modulus of about 90% or less of that of a sheet without such material measured in any direction parallel to the sheet surface.

2. A sheet according to claim 1 which has been stretched in at least one linear dimension (optionally in two substantially orthogonal directions more optionally in a machine direction and in a transverse direction) from an initial size to a final size and the at least one layer comprises as a bulk and/or continuous phase a first optionally polymeric material having an elasticity modulus from about 2000 to about 3000 MPa and a second optionally polymeric material of elasticity modulus from about 1000 to about 2500 MPa homogeneously dispersed or dissolved therein, the elasticity modulus of the second material being lower than the elasticity modulus of the first material, the second material being present in the conformability layer in an amount from about 5% to about 30% by weight of the first material; the sheet exhibiting one or more of the following properties:
measured in the machine direction:
(b) an elasticity modulus below about 2600 MPa;
(c) a percentage elongation to break after manufacture below about 90%;
(d) a percentage shrinkage after manufacture of below about 7% when the sheet is heated to 130° C. for one minute;
measured in the transverse direction:
(e) an elasticity modulus from about 1800 to about 2200 MPa;
(f) a percentage elongation to break after manufacture of below about 120%; and/or
(g) a percentage shrinkage after manufacture of below about 3.0% when the sheet is heated to 130° C. for one minute.

3. A sheet according to claim either preceding claim, in which the first polymeric material comprises an homopolymer and/or a polymer of randomly oriented amorphous non-crystalline polymer chains.

4. A sheet according to any preceding claim, in which the first polymeric material comprises a polyolefin.

5. A sheet according to claim 4, in which the polyolefin comprises polypropylene optionally biaxially oriented.

6. A sheet according to any preceding claim, in which the second polymeric material comprises an elastomer and/or polyolefin.

7. A sheet according to claim 6, in which the second polymeric material comprises at least one polymer selected from at least one of the group consisting of homopolymers and copolymers including one or more repeat units derived from any ethylenic polymer precursor; copolymers including one or more repeat units derived from any propylenic polymer precursor; copolymers including one or more repeat units derived from any styrenic polymer precursor; copolymers including one or more repeat units derived from any CH₂═CHR (R denotes any saturated C₁₋₂₀ hydrocarbon group, preferably C₁₋₁₀ alkyl) olefinic polymer precursor; and/or copolymers including one or more repeat units derived from any norbornenic polymer precursor.

8. A sheet according to any preceding claim in which the second polymeric material is present in the or each conformable layer(s) in amount of from about 5 to about 30% by weight of the first polymeric material.

9. A sheet according to any preceding claim comprising a plurality of layers.

10. A sheet according to claim 9, comprising at least three layers where the or each conformable layer is sandwiched between other layers such that none of the or each conformable layers forms either surface of the sheet.

11. A sheet according to any preceding claim, having an elasticity modulus of from about 1600 to about 2600 MPa measured in the machine direction.

12. A sheet according to any preceding claim, having an percentage elongation during manufacture of from about 60% about 85%. measured in the machine direction,

13. A sheet according to any preceding claim, having a percentage shrinkage after manufacture and heating at 130° C. for one minute of from about 5% to about 7% measured in the machine direction.

14. A sheet according to any preceding claim, having an elasticity modulus of from about 1200 to about 2200 Mpa m asured in the transverse direction.

15. A sheet according to any preceding claim, having a percentage elongation after manufacture of from about 110% to about 115% measured in the transverse direction.

16. A sheet according to any preceding claim, having a percentage shrinkage after manufacture and heating to 130° C. for one minute of from about zero to about 2.5% measured in the transverse direction.

17. A sheet according to any preceding claim, having a mean thickness above about 75 μm.

18. A sheet according to any preceding claim, including a free radical scavenger and/or a UV attenuating material optionally located in the conformable layer (preferably in an amount of from about 0.1% to about 0.5% by weight of the first material) such that the sheet retains at least 50% of its mechanical properties after exposure to artificial weathering for 2500 hours.

19. A label, security, marking, graphic art and/or display device comprising a sheet according to any preceding claim.

20. A label of optionally improved conformability, the label comprising a first backing sheet coated with a release layer on top of which is attached a second sheet according to any of claims 1 to 18, the second sheet being optionally provided with a printable coating on the side opposed to the first (backing) sheet.

21. Use of a sheet according to any of claims 1 to 18 in a method of manufacture of a label security, marking and/or display device.

22. Use of a sheet according to any of claims 1 to 18 in a method of labelling, security marking and/or display.

23. Use of a first and/or second polymeric material as defined in any of claims 1 to 18, for the purpose of enhancing in a sheet as claimed in any of claims 1 to 18, defined herein (optionally the sheet exhibiting improved conformability) one or more properties the properties being selected from:
(a) tensile strength optionally from about 100 to about 250 Nm⁻²;
(b) elasticity modulus optionally from about 2100 to about 3100 MPa;
(c) percentage elongation optionally below about 150%; and/or
(d) percentage shrinkage optionally below about 7%.
